(19) United States
(12) Patent Application Publication
(10) Pub. No.: US 2021/0362376 A1
(43) Pub. Date: Nov. 25, 2021

(54) Cavity Mold and Cavity Mold System

(71) Applicant: Eastern Petroleum Services B.V., Curacao (CW)

(72) Inventor: Gordon William Thomas, Curacao (CW)

(21) Appl. No.: 17/324,080

(22) Filed: May 18, 2021

(30) Foreign Application Priority Data
May 21, 2020 (SG) 10202004764Y

(51) Int. Cl. B29C 33/04; B29C 33/00; B29C 33/10; B29C 33/22; B29C 33/34

(52) U.S. Cl. CPC B29C 33/04; B29C 33/0038; B29C 33/0061; B29C 33/34; B29C 33/10; B29C 33/22; B29C 33/0083

(57) ABSTRACT

A cavity mold comprises two or more sub-molds; and one or more gasket disposed between two adjacent sub-molds; wherein the gasket seals heating and cooling mediums when the cavity mold is assembled; wherein each of the two or more sub-molds comprises an outer casing; an inner casing on which a molded item is formed, wherein the cavity mold is assembled, a cavity is formed in the space between the outer casing and the inner casing; at least one heating/cooling mediums input pipe that is fluidly coupled with heating and cooling medium sources and the cavity, wherein heating and cooling mediums are pumped or compressed via the at least one heating/cooling mediums input pipe into the cavity, thereby the heating and cooling mediums pass through the cavity of the cavity mold; and at least one heating/cooling mediums return pipe that is fluidly coupled with the heating and cooling medium sources and the cavity, wherein the heating and cooling mediums are pumped via the at least one heating/cooling mediums return pipe out of the cavity; and wherein at least one of the two or more sub-molds further comprises a feed channel being through the outer casing and the inner casing; wherein the feed channel allows molding materials to be fed into the inside of the inner casing. A cavity mold system employs the cavity mold.

### FIELD OF THE INVENTION

The present invention relates to molding, and particularly to a cavity mold with direct internal heating and cooling, and to a cavity mold system employing the cavity mold, where the cavity mold system is able to produce rotationally molded items at one work station.

### BACKGROUND OF THE INVENTION

Rotational molding is how most hollow plastic items including large containers are made. The rotational molding usually follows the procedures:

inserting plastic powder or pellets into a mold;

bolting the mold together on a frame;

placing the complete mold and the structure holding the mold(s) into an oven;

heating the mold so that the polymer/plastic powder or pellets are melt and distributed evenly over the inner surface of the mold by rotating the mold bi-directionally in the oven; the heating of the mold inner surface is critical and the temperature has to be raised to the melt point of the type of material being utilized; the amount of powder or pellets that are injected into the mold governs the thickness of the molded item;

removing the mold to a cooling area, still being rotated, to keep the layer inside the mold from deforming (sagging) as it gradually cools; the rate of cooling is also critical to the quality of the finished product avoiding distortions etc.; and

finally moving the mold to a demolding area where the mold is opened and the molded item removed.

The mold can then be bolted back together and the production cycle starts all over again.

Materials in liquid form can also be placed in the molds following the same process. This is referred to as “slush” molding.

The main constraints of current rotational molding include that:

(i) the control of heating and cooling of the internal surface of the molds is inaccurate and often uneven;

(ii) the rotational molding equipment is very large, exceedingly heavy, and expensive;

(iii) to run the operation is very expensive;

(iv) heavy consumption of energy results in air pollution; and

(v) a very large factory space is required.

The operation of the current rotational molding typically requires three factory areas:

1. Assembly & demolding area for assembling molds to start the process and demolding for removing the molded items after the process is completed; bolting/unbolting the molds onto a support frame (spider) is often a manual process;

2. Heating area for housing an oven into which the molds on the frame are inserted; the oven that needs to continuously burn fuel (diesel, fuel oil, kerosene or gas) with the majority of the heat being lost up the chimney is terribly inefficient and emits serious volumes of CO₂ and other pollutants; and

3. Cooling area as cooling station; the molds and supporting frame(s) are cooled down using forced air and/or water spray; after cooling, the frame and molds are returned to the assembly & demolding area; control over the cooling rate of the inner mold surface and/or molded items by way of this crude manner is minimal.

Therefore, there is an imperative need to fully or substantially eliminate the constraints existing in the current rotational molding.

### SUMMARY OF THE INVENTION

The present invention provides a cavity mold. In certain embodiments, the cavity mold comprises two or more sub-molds; and one or more gasket disposed between two adjacent sub-molds; wherein the gasket seals heating and cooling mediums when the cavity mold is assembled; wherein each of the two or more sub-molds comprises an outer casing; an inner casing on which a molded item is formed, wherein the cavity mold is assembled, a cavity is formed in the space between the outer casing and the inner casing; at least one heating/cooling mediums input pipe that is fluidly coupled with heating and cooling medium sources and the cavity, wherein heating and cooling mediums are pumped or compressed via the at least one heating/cooling mediums input pipe into the cavity, thereby the heating and cooling mediums pass through the cavity of the cavity mold; and at least one heating/cooling mediums return pipe that is fluidly coupled with the heating and cooling medium sources and the cavity, wherein the heating and cooling mediums are pumped via the at least one heating/cooling mediums return pipe out of the cavity; and wherein at least one of the two or more sub-molds further comprises a feed channel being through the outer casing and the inner casing; wherein the feed channel allows molding materials to be fed into the inside of the inner casing.

In certain embodiments of the cavity mold, each of the two or more sub-molds further comprises at least two isolation valves for regulating the heating or cooling medium flows; wherein one of the at least two isolation valves is disposed on the at least one heating/cooling mediums input pipe, and one of the at least two isolation valves is disposed at least one heating/cooling mediums return pipe.

In certain embodiments of the cavity mold, each of the two or more sub-molds further comprises at least one temperature sensor being disposed on the outer casing and inside the cavity for recording the temperature of the heating and cooling mediums.

In certain embodiments of the cavity mold, the feed channel serves as a vent to release any pressure inside the cavity mold.

In certain embodiments of the cavity mold, each of the two or more sub-molds further comprises at least two bushes being provided on the mold flange of the sub-molds for allowing a guide rod to ensure accurate alignment of the sub-molds.

In certain embodiments of the cavity mold, the inner casing and the outer casing can be assembled and disassembled.

In certain embodiments of the cavity mold, the inner casing and the outer casing are fixed together.

In certain embodiments of the cavity mold, the at least two isolation valves enable removal or replacement of the cavity mold.

The present invention also provides a rotational frame subsystem.

In certain embodiments, the rotational frame subsystem comprises an inner frame serving as a secondary rotating carriage supporting the cavity mold and opening/closing the cavity mold; an outer frame serving as a primary rotating carriage; wherein the inner frame is disposed within the outer frame; a support structure; an inner frame driving motor being disposed onto the outer frame, and being mechanically coupled with the inner frame; wherein the inner frame driving motor revolves the inner frame as the secondary rotation; and an outer frame driving motor being disposed onto the support structure via a motor joint, and mechanically coupled with the outer frame, where the outer frame driving motor revolves the outer frame as the main rotation; and a first multi-pipe rotary joint being mounted on the support structure and connecting the outer frame to the support structure; a second multi-pipe rotary joint being mounted on an inner frame and connecting the outer frame and the inner frame; wherein the first multi-pipe rotary joint allows pipes for input medium and return medium to be fed along a member of the outer frame to the second multi-pipe rotary joint; wherein the second multi-pipe rotary joint is fluidly coupled with a heating/cooling medium input pipe so that the heating/cooling input medium is fed into the cavity of the cavity mold; and wherein the second multi-pipe rotary joint is also fluidly coupled with a heating/cooling medium return pipe so that the heating/cooling return medium from the cavity of the cavity mold is returned to the first multi-pipe rotary joint.

In certain embodiments, the rotational frame subsystem further comprises a guide rod being fitted onto the inner frame, wherein the cavity mold slides along the guide rod to ensure accurate mating of the sub-molds.

In certain embodiments of the rotational frame subsystem, the inner frame driving motor is electrically coupled with an electrical supply panel by a power cable that is fitted along the outer frame, and the power cable passes an electrical slip ring that is fitted in the motor joint being disposed onto the support structure.

In certain embodiments, the rotational frame subsystem further comprises means for opening and closing the sub-molds of the cavity molds.

In certain embodiments of the rotational frame subsystem, the first or second multi-pipe rotary joint comprises an upper flanged both ends tube; three swivel connectors; supports; wherein the three swivel connectors are mounted on the supports and disposed within the upper flanged both ends tube; and a slew bearing being disposed between the upper flanged both ends tube when the joints are assembled.

In certain embodiments of the rotational frame subsystem, the first or second multi-pipe rotary joint comprises an input pipe insert being fitted over a hydraulic/pneumatic line, and fed by the heating/cooling medium input pipe for carrying the input heating and cooling mediums; a return pipe insert being fitted over the input pipe insert, and fed by the heating/cooling medium return pipe for carrying the return heating and cooling mediums; thereby the first and second multi-pipe rotary joints have a pipe within pipe configuration.

The present invention also provides a cavity mold system.

In certain embodiments, the cavity mold system comprises a cavity mold comprising two or more sub-molds; and one or more gasket disposed between two adjacent sub-molds; wherein the gasket seals heating and cooling mediums when the cavity mold is assembled; wherein each of the two or more sub-molds comprises an outer casing; an inner casing on which a molded item is formed, wherein the cavity mold is assembled, a cavity is formed in the space between the outer casing and the inner casing; at least one heating/cooling mediums input pipe that is fluidly coupled with heating and cooling medium sources and the cavity, wherein heating and cooling mediums are pumped or compressed via the at least one heating/cooling mediums input pipe into the cavity, thereby the heating and cooling mediums pass through the cavity of the cavity mold; and at least one heating/cooling mediums return pipe that is fluidly coupled with the heating and cooling medium sources and the cavity, wherein the heating and cooling mediums are pumped via the at least one heating/cooling mediums return pipe out of the cavity; and wherein at least one of the two or more sub-molds further comprises a feed channel being through the outer casing and the inner casing; wherein the feed channel allows molding materials to be fed into the inside of the inner casing; a rotational frame subsystem comprising an inner frame serving as a secondary rotating carriage supporting the cavity mold and opening/closing the cavity mold; an outer frame serving as a primary rotating carriage; wherein the inner frame is disposed within the outer frame; a support structure; an inner frame driving motor being disposed onto the outer frame, and being mechanically coupled with the inner frame; wherein the inner frame driving motor revolves the inner frame as the secondary rotation; and an outer frame driving motor being disposed onto the support structure via a motor joint, and mechanically coupled with the outer frame, where the outer frame driving motor revolves the outer frame as the main rotation; and a first multi-pipe rotary joint being mounted on the support structure and connecting the outer frame to the support structure; a second multi-pipe rotary joint being mounted on an inner frame and connecting the outer frame and the inner frame; wherein the first multi-pipe rotary joint allows pipes for input medium and return medium to be fed along a member of the outer frame to the second multi-pipe rotary joint; wherein the second multi-pipe rotary joint is fluidly coupled with the heating/cooling medium input pipe so that the heating/cooling input medium is fed into the cavity of the cavity mold; and wherein the second multi-pipe rotary joint is also fluidly coupled with the heating/cooling medium return pipe so that the heating/cooling return medium from the cavity of the cavity mold is returned to the first multi-pipe rotary joint; and a heating and cooling medium subsystem for providing the heating and cooling mediums and controlling the temperatures of the heating and cooling mediums.

In certain embodiments of the cavity mold system, the rotational frame subsystem further comprises a guide rod being fitted onto the inner frame, wherein the cavity mold slides along the guide rod to ensure accurate mating of the sub-molds.

In certain embodiments of the cavity mold system, the inner frame driving motor is electrically coupled with an electrical supply panel by a power cable that is fitted along the outer frame, and the power cable passes an electrical slip ring that is fitted in the motor joint being disposed onto the support structure.

In certain embodiments of the cavity mold system, the rotational frame subsystem further comprises means for opening and closing the sub-molds of the cavity molds.

In certain embodiments of the cavity mold system, the heating and cooling medium subsystem comprises a heating medium storage tank for storing the heating medium; a heating medium pump being disposed downstream of the heating medium storage tank; a heating medium metering means being disposed downstream of the heating medium pump; wherein the heating medium metering means monitors the temperature, volume and density of the heating medium passing through and feeds data to a PLC; a heating medium control valve being disposed downstream of the heating medium metering means; wherein the heating medium control valve adjusts the flow of the heating medium based on the PLC output command; a cooling medium storage tank for storing the cooling medium; a cooling medium pump being disposed downstream of the cooling medium storage tank; a cooling medium metering means being disposed downstream of the cooling medium pump; wherein the cooling medium metering means monitors the temperature, volume and density of the cooling medium passing through and feeds data to the PLC; a cooling medium control valve being disposed downstream of the cooling medium metering means; wherein the cooling medium control valve adjusts the flow of the cooling medium based on the PLC output command; an inline mixer being disposed downstream of both the heating medium control valve and the cooling medium control valve; wherein the inline mixer mixes the heating and cooling mediums are mixed to give a desired temperature to a heating/cooling input medium; a heating medium return control valve being disposed downstream of the first multi-pipe rotary joint; wherein the heating medium return control valve is controlled by the PLC to direct the heating return medium to the heating medium storage tank; and a cooling medium return control valve being disposed downstream of the first multi-pipe rotary joint; wherein the cooling medium return control valve is controlled by the PLC to direct the cooling return medium to the cooling medium storage tank.

In certain embodiments of the cavity mold system, the heating medium metering means and the cooling medium metering means are a Coriolis meter.

In certain embodiments of the cavity mold system, the first or second multi-pipe rotary joint comprises an upper flanged both ends tube; three swivel connectors; supports; wherein the three swivel connectors are mounted on the supports and disposed within the upper flanged both ends tube; and a slew bearing being disposed between the upper flanged both ends tube when the joints are assembled.

In certain embodiments of the cavity mold system, the first or second multi-pipe rotary joint comprises an input pipe insert being fitted over a hydraulic/pneumatic line, and fed by the heating/cooling medium input pipe for carrying the input heating and cooling mediums; a return pipe insert being fitted over the input pipe insert, and fed by the heating/cooling medium return pipe for carrying the return heating and cooling mediums; thereby the first and second multi-pipe rotary joints have a pipe within pipe configuration.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 shows a schematic view of the cavity mold in accordance with one embodiment of the present invention.

FIG. 2 shows a schematic view of the cavity mold in accordance with another embodiment of the present invention.

FIG. 3 shows a schematic diagram illustrating the heating and cooling subsystem in accordance with one embodiment of the present invention.

FIG. 4 shows a schematic diagram and perspective views of the cavity mold system in accordance with one embodiment of the present invention.

FIG. 5 shows various views of the multi-pipe rotary joints in accordance with certain embodiments of the present invention.

FIG. 6 provides schematic diagrams showing the demolding and ejection of molded parts in accordance with certain embodiments of the present invention.

FIG. 7 provides schematic diagrams showing the filing and opening of the mold in accordance with certain embodiments of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

The present invention provides a cavity mold system that accurately controls the heat and cooling of the inner casing of the molds and thereby maximizes control over the melting and cooling of the raw material being molded.

The cavity mold system of the present invention comprises a cavity mold, a heating and cooling subsystem, and a bi-directional rotating subsystem. In brief, the cavity mold has a cavity formed between an inner casing and an outer casing. The heating and cooling subsystem monitors and controls the temperature of the mold. The bi-directional rotating subsystem enables to the heating and cooling media to be pumped into and out of the cavity during mold rotation.

For the cavity mold system of the present invention, to heat the mold, hot medium is pumped into and through the cavity of the mold transferring the required heat onto the inner process surface of the mold. The temperature of the heating medium is gradually increased to the desired optimum temperature for the material being molded. The temperature of the heating medium is adjusted by mixing hot and cold medium via a proportioning device (e.g., Coriolis meters or other similar devices) controlled by a Programmable Logic Controller (PLC).

Once the molten material has been evenly spread over the entire inner surface of the mold, the hot medium is replaced by pumping or compressing the cooling medium into the mold cavities which in turn solidifies the product lining the inner surface of the molds. The heating medium is driven out by the cooling medium and returned to the storage tank.

The cavity mold of the present invention can have various configuration and dimensions. For example, one cavity mold can have 2, 3 or even 4 sub-molds, where each sub-mold has its own configuration and dimension. When being used for production operation, all sub-molds are mated together to form one cavity mold.

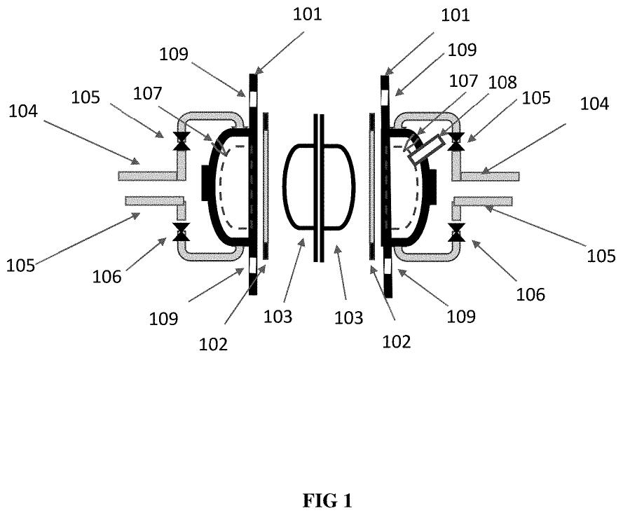

Referring now to FIG. 1, there is provided a schematic view of the cavity mold in accordance with one embodiment of the present invention.

As shown in FIG. 1, the cavity mold 100 has two sub-molds, where each sub-mold comprises:

an outer casing 101;

a gasket 102 disposed between the joint of two sub-molds of the cavity mold 100; where the gasket 102 seals heating and cooling mediums when the two sub-molds are assembled into the cavity mold 100; and

an inner casing 103 on which a rotational molded item is formed, where the inner casing 103 can be disassembled from the outer casing 101.

The outer casing 101, the gasket 102, and the outer casing 103 are assembled to form one sub-mold. When the two sub-molds are assembled into the cavity mold 100, a cavity is formed in the space between the outer casing 101 (the broken lines) and the inner casing 103.

Referring still to FIG. 1, each sub-mold of the cavity mold 100 further comprises:

at least one heating/cooling mediums input pipe 104 that is fluidly coupled with heating and cooling medium sources of the heating and cooling subsystem as described hereinbelow, where the heating and cooling mediums are pumped or compressed via the at least one heating/cooling mediums input pipe 104 into the cavity, thereby the heating and cooling mediums pass through the cavity of the cavity mold 100;

at least one heating/cooling mediums return pipe 105 that is fluidly coupled with heating and cooling medium sources of the heating and cooling subsystem as described hereinbelow, where the heating and cooling mediums are pumped via at least one heating/cooling mediums return pipe 105 out of the cavity.

at least two isolation valves 106 for regulating the heating or cooling medium flows; where one of the at least two isolation valves 106 is disposed on the at least one heating/cooling mediums input pipe 104, and one of the at least two isolation valves 106 is disposed at least one heating/cooling mediums return pipe 105; and where the isolation valves 106 enables removal or replacement of cavity molds 100;

at least one temperature sensor 107 being disposed on the outer casing 101 of each sub-mold and inside the cavity for recording the temperature of the heating and cooling mediums; and

Referring still to FIG. 1, at least one sub-mold of the cavity mold 100 further comprises a feed channel 108 being through the outer casing 101 and the inner casing 103, where the feed channel 108 allows molding materials to be fed into the inside of the inner casing 103. In certain embodiments, the feed channel 108 is provided at all sub-molds of the cavity mold 100. The feed channel 108 is also a vent to release any pressure that may build up inside the mold.

Referring still to FIG. 1, at least two bushes 109 are provided on the mold flange of the sub-molds, where the bushes 109 allow a guide rod to ensure accurate alignment of the sub-molds.

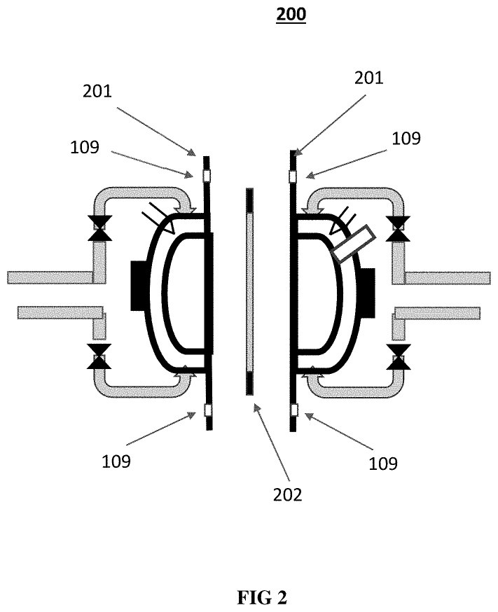

Referring now to FIG. 2, there is provided a schematic view of the cavity mold in accordance with another embodiment of the present invention.

As shown in FIG. 2, the cavity mold 200 has a similar configuration to the cavity mold 100 as shown in FIG. 1, except for two aspects:

First, in each sub-mold 201, the outer casing and inner casing are fixed (e.g. welded, cast, molded) together, and cavity is formed in the space between the outer casing and inner casing;

Second, one gasket 202 is disposed between the two fixed sub-molds 201; thereby, the two fixed sub-molds 201 and the gasket 202 are assembled into the cavity mold 200.

The heating/cooling medium input pipe, heating/cooling mediums return pipe, isolation valves, temperature sensor, feed channel, and bushes 109 are similar to the ones as described in FIG. 1.

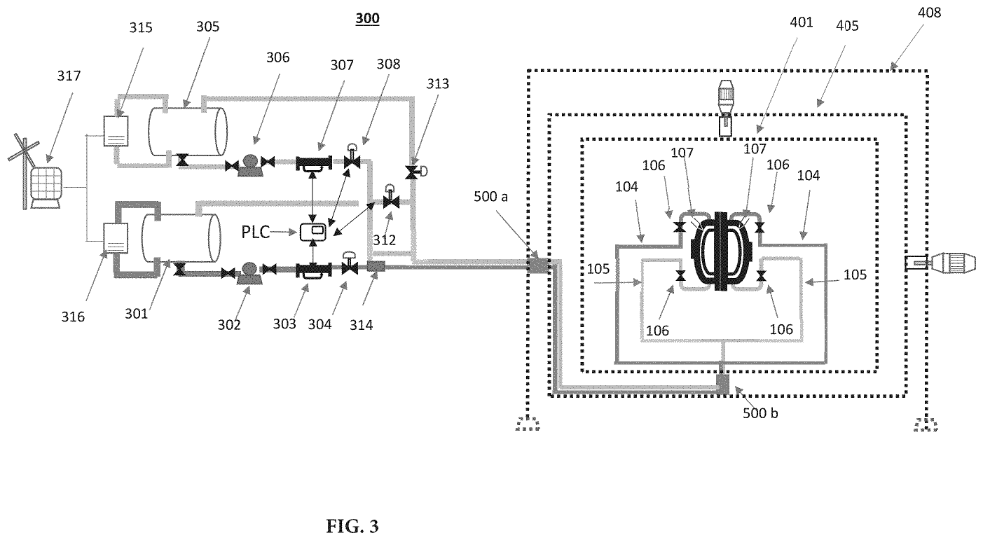

Referring now to FIG. 3, there is provided a schematic diagram of the cavity mold system in accordance with one embodiment of the present invention, where a preferred configuration of the heating and cooling subsystem is provided. The heating and cooling subsystem controls the temperatures of the heating and cooling mediums. In principle, heating medium and cooling medium are kept in separate storage tanks and pumped through metering means (e.g. Coriolis meter) so that the heating and cooling mediums are mixed in an inline mixer 314 to give a desired temperature. The metering means are controlled by a Programmable Logic Controller (PLC).

As shown in FIG. 3, the heating and cooling subsystem 300 comprises:

a heating medium storage tank 301 for storing the heating medium; in certain embodiments, the heating medium is received from a heater 316, and the heater 316 can be coupled to a renewable energy source 317; in certain embodiments, the heating medium storage tank 301 keeps the heating medium at a constant temperature by e.g. utilizing the heater 316; in certain embodiments, the heater 316 could be installed inside the heating medium storage tank 301;

a heating medium pump 302 being disposed downstream of the heating medium storage tank 301, where the heating medium pump 302 feeds the heated medium at the stored temperature from the heating medium storage tank 301;

a heating medium metering means 303 being disposed downstream of the heating medium pump 302, where the heating medium metering means 303 monitors the temperature, volume and density of the heating medium passing through and feeds data to the PLC; in certain embodiments, the heating medium metering means 303 is a Coriolis meter;

a heating medium control valve 304 being disposed downstream of the heating medium metering means 303, where the heating medium control valve 304 adjusts the flow of the heating medium based on the PLC output command;

a cooling medium storage tank 305 for storing the cooling medium received from a chiller 315; in certain embodiments, the chiller 315 can be coupled to a renewable energy source 317; in certain embodiments, the cooling medium storage tank 305 keeps the cooling medium at a constant temperature by e.g. the chiller 315;

a cooling medium pump 306 being disposed downstream of the cooling medium storage tank 305, where the cooling medium pump feeds the cooling medium at the stored temperature from the cooling medium storage tank 305;

a cooling medium metering means 307 being disposed downstream of the cooling medium pump 306, where in the cooling medium metering means monitors the temperature, volume and density of the cooling medium passing through and feeds data to the PLC; in certain embodiments, the cooling medium metering means 303 is a Coriolis meter;

a cooling medium control valve 308 being disposed downstream of the cooling medium metering means 307, where the cooling medium control valve 308 adjusts the flow of the cooling medium based on the PLC output command;

an inline mixer 314 being disposed downstream of both the heating medium control valve 304 and the cooling medium control valve 308, where the inline mixer 314 mixes the heating and cooling mediums are mixed to give a desired temperature to a heating/cooling input medium;

a first multi-pipe rotary joint 500a and a second multi-pipe rotary joint 500b being sequentially disposed downstream of the inline mixer 314 to receive the heating/cooling input medium, wherein the first multi-pipe rotary joint 500a is mounted between an outer frame 405 and a support structure 408, and the second multi-pipe rotary joint 500b is mounted on an inner frame 401; where the first multi-pipe rotary joint 500a allows pipes for input medium and return medium to be fed along a member of the outer frame to the second multi-pipe rotary joint 500b; where the second multi-pipe rotary joint 500b is fluidly coupled with the heating/cooling medium input pipe 104 so that the heating/cooling input medium is fed into the cavity of the cavity mold 100, and where the second multi-pipe rotary joint 500b is also fluidly coupled with the heating/cooling medium return pipe 105 so that the heating/cooling return medium from the cavity of the cavity mold 100 is returned to the first multi-pipe rotary joint 500a;

a heating medium return control valve 312 being disposed downstream of the first multi-pipe rotary joint 500a; where the heating medium return control valve 312 is controlled by the PLC to direct the heating return medium to the heating medium storage tank 301; and

a cooling medium return control valve 313 being disposed downstream of the first multi-pipe rotary joint 500a; where the cooling medium return control valve 313 is controlled by the PLC to direct the cooling return medium to the cooling medium storage tank 305.

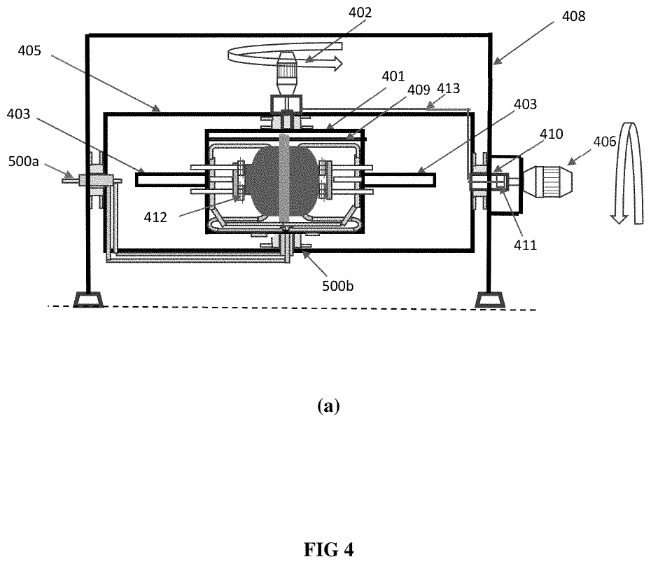

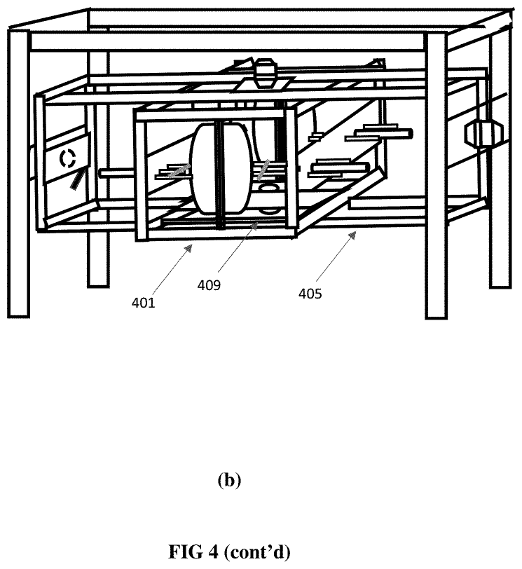

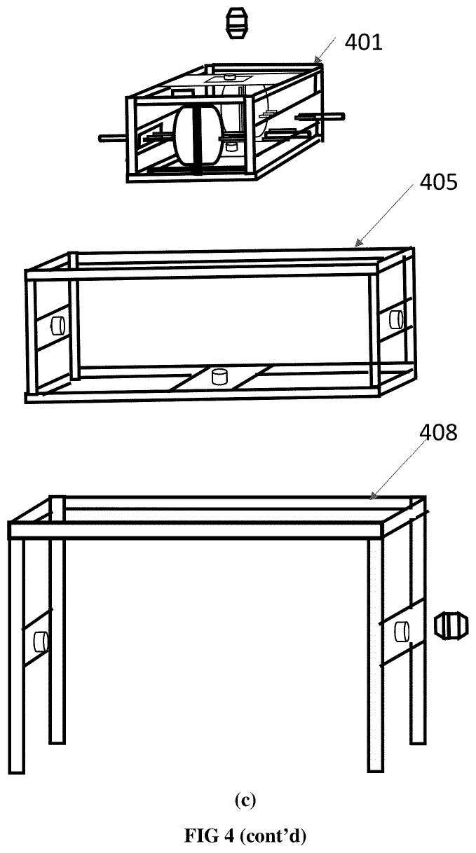

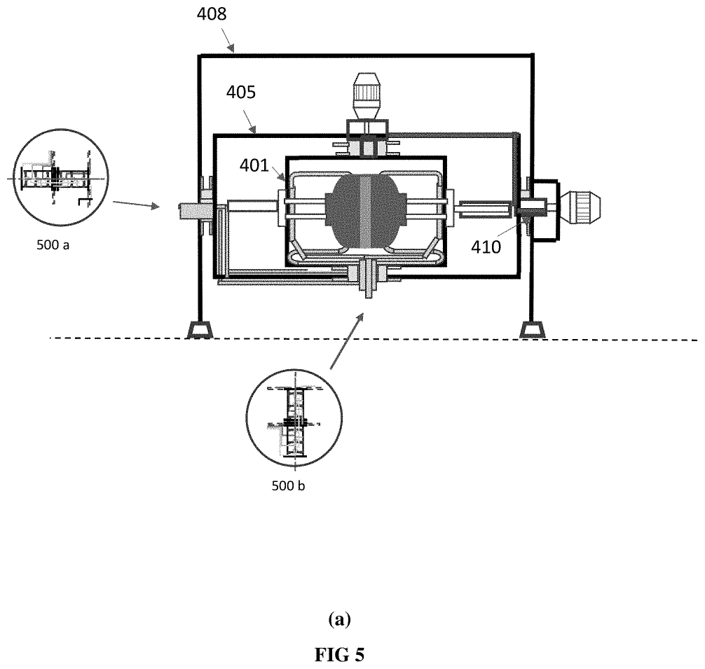

Referring now to FIG. 4, there are provided (a) a schematic diagram, (b) a perspective view (assembled), and (c) a perspective view (disassembled) of the cavity mold system in accordance with one embodiment of the present invention, where a preferred configuration of a bi-directional rotating subsystem 400 is provided, where the heating and cooling subsystem 300 is not shown, and where the cavity mold 100, 200 is included. As shown in FIG. 4, the bi-directional rotating subsystem 400 comprises:

an inner frame (i.e. spider) 401 serving as a secondary rotating carriage supporting the molds and opening/closing the molds;

an outer frame 405 serving as a primary rotating carriage, where the inner frame 401 is disposed within and supported by the outer frame 405 that in turn is supported by a support structure 408;

an inner frame driving motor 402 being disposed onto the outer frame 405 mechanically coupled with the inner frame 401, where the inner frame driving motor 402 revolves the inner frame 401 as the secondary rotation; in certain embodiments, the inner frame driving motor 402 is electrically coupled with an electrical supply panel by a power cable 413 that is fitted along the outer frame 405, and the power cable 413 passes an electrical slip ring 411 that is fitted in a motor joint 410 being disposed onto the support structure 408; in certain embodiment, the electrical slip ring 411 can be commercially available.

means 403 for opening and closing the sub-molds of the cavity molds; in certain embodiments, the means 403 are attached to the inner frame 401 until the time when the mold is being changed;

an outer frame driving motor 406 being disposed onto the support structure 408 via the motor joint 410, and mechanically coupled with the outer frame 405, where the outer frame driving motor 406 revolves the outer frame 405 as the main rotation;

a guide rod 409 being fitted onto the inner frame 401, where the molds slide along the guide rod 409 to ensure accurate mating of the sub-molds;

a plurality of springs 412 being disposed between the means 403 and the cavity mold 100, 200 to ensure that the pressure is maintained to keep the sub-molds closed.

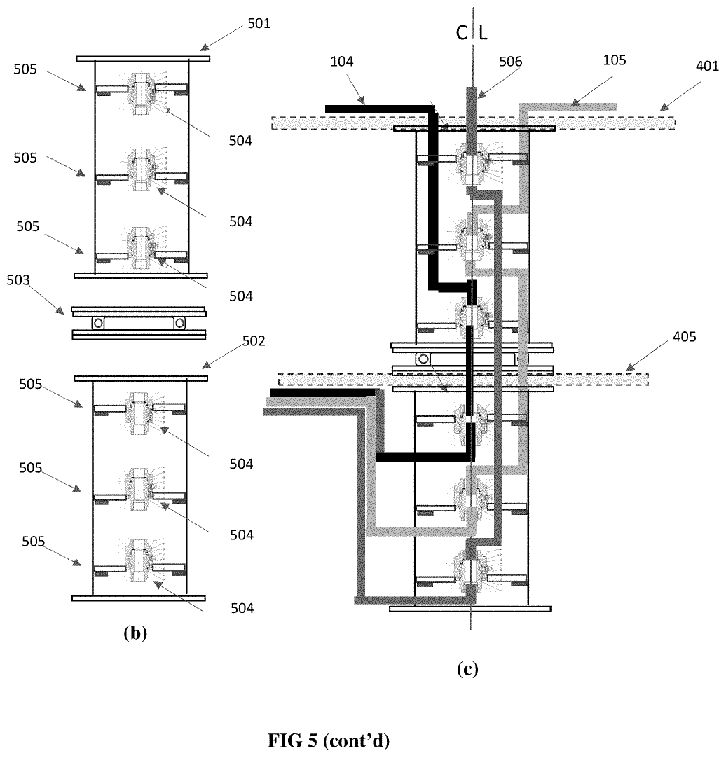

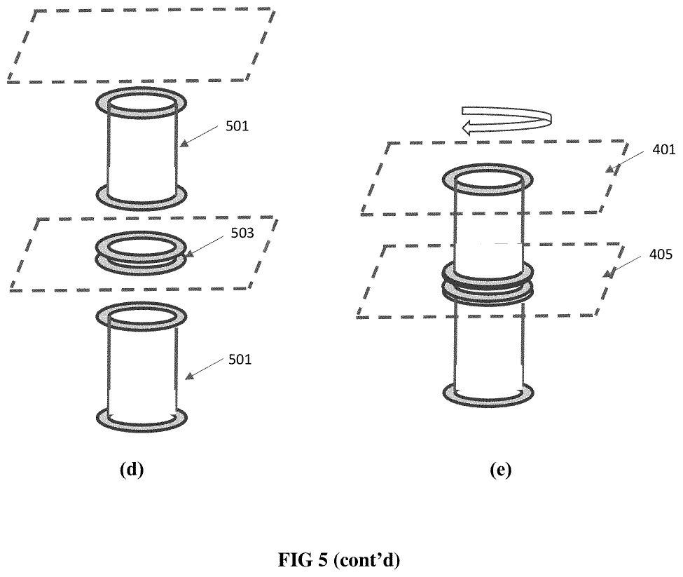

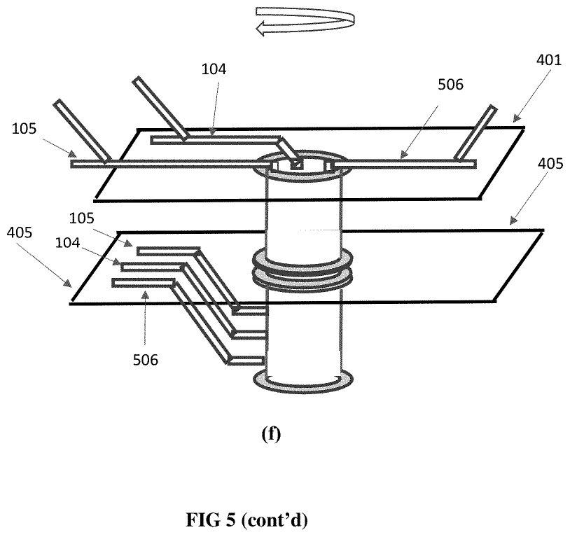

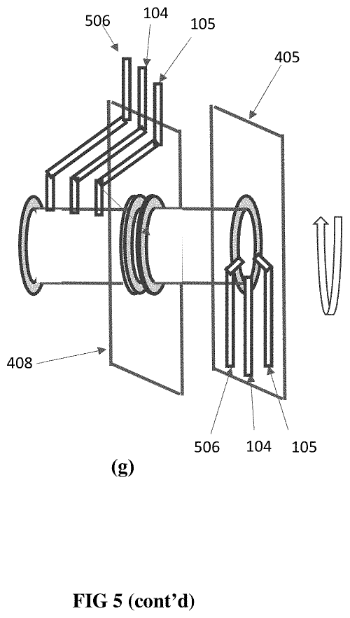

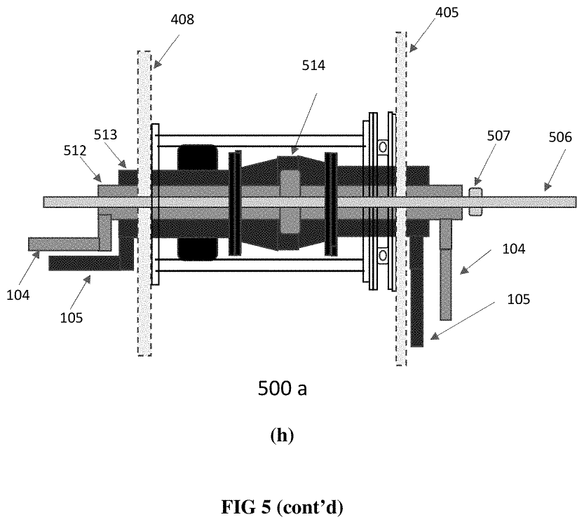

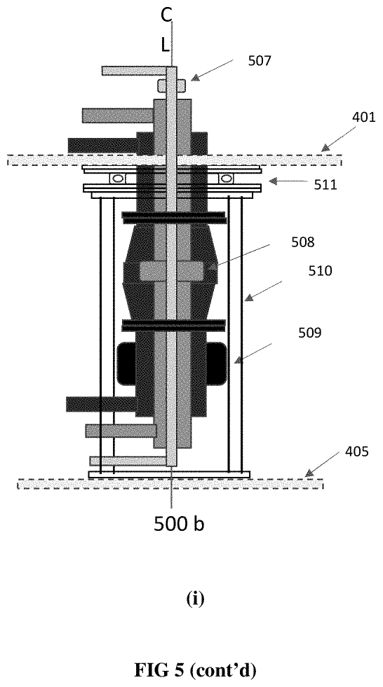

Referring now to FIG. 5, there are provided various views of the multi-pipe rotary joints in accordance with certain embodiments of the present invention. The multi-pipe rotary joints allow the heating/cooling medium input and return pipes to carry the heating and cooling mediums to the cavity of cavity molds and to return the storage tanks. The multi-pipe rotary joints also allow the hoses for hydraulic or pneumatic oil/air required to operate the opening and closing mechanism for the molds.

Referring now to FIG. 5(a), the first multi-pipe rotary joint 500a connects the outer frame 405 to the support structure 408, and the second multi-pipe rotary joint 500b connects the outer frame 405 and the inner frame 401. The first multi-pipe rotary joint 500a allows the pipes, tubes or hoses originated from the proportioning supply and hydraulic/pneumatic systems to be fed through the support structure 408 and affixed to the outer frame 405. The first multi-pipe rotary joint 500a not only allows the pipes, tubes or hoses to rotate on the outer frame 405 but also acts as one of the supports between the outer frame 405 and the support structure 408. The second multi-pipe rotary joint 500b not only allows the pipes, tubes or hoses to rotate on the inner frame 401 but also acts as one of the supports between the outer frame 405 and the inner frame 401.

Referring now to FIG. 5(b), there is provided a section view of the first/second multi-pipe rotary joints 500a, 500b showing the components that, when assembled, form the multi-pipe rotary joints. The multi-pipe rotary joints 500a, 500b comprise an upper flanged both ends tube 501, three swivel connectors 504, and supports 505, where the three swivel connectors 504 are mounted on the supports 505 and disposed within the tubes 501, 502. The multi-pipe rotary joints 500a, 500b further comprise a slew bearing 503 being disposed between the tube 501 when the joints are assembled. The lower section 502 is similar to the upper section 501.

Referring now to FIG. 5(c), there is provided a section view of the second multi-pipe rotary joint 500b showing how the pipes, tubes or hoses are affixed to the rotary connectors. In certain embodiments, the rotary connectors can be commercially available ones. The connectors must be such that they are all mounted on the center line of the rotating axis of the frame. Each pipe, tube or hose has two rotary connectors to avoid clashes of lines.

The center line of the first multi-pipe rotating joint 500a is of the outer frame 405. The configuration of the pipes, tubes or hoses is such that pipes, tubes or hoses attached to the outer frame 405 can rotate while the pipes, tubes or hoses can be affixed the outer structure support 408 avoiding clashes of pipes, tubes or hoses. The configuration of the first multi-pipe rotary joint 500a shares the same principle of that of the second multi-pipe rotary joint 500b.

Referring now to FIGS. 5(d) and (e), there are provided perspective views of the second multi-pipe rotary joint.

Referring now to FIG. 5(f), there is provided a perspective view of the second multi-pipe rotary joint 500b, where the pipes, tubes or hoses would affix to a structural member of the inner frame 401 and to structural member of the outer frame 405.

Referring now to FIG. 5(g), there is provided a perspective view of the first multi-pipe rotary joint 500a, where the pipes, tubes or hoses would affix to a structural member of the outer frame 405 and to structural member of the support structure 408, leading to the heating and cooling mediums and hydraulic/pneumatic systems.

Referring now to FIGS. 5(h) and (i), there are provided schematic views of the first and second multi-pipe rotary joints 500a, 500b in accordance with another embodiment of the present invention. As shown in FIGS. 5(h) and (i), the first and second multi-pipe rotary joints 500a, 500b have a pipe within pipe configuration, where the pipe, tube or hose carrying the hydraulic oil of pneumatic air 506 forms the core of the multi-pipe rotary joints 500a, 500b, and the swivel connector 507 for the hydraulic/pneumatic line 506 is fitted outside of the multi-pipe rotary joints 500a, 500b.

The pipe insert 512 is fitted over the hydraulic/pneumatic line 506, and fed by the heating/cooling medium input pipe 104 for carrying the input heating and cooling mediums. The swivel connector 508 for the pipe insert 512 is fitted inside a pipe insert 513.

The pipe insert 513 is fitted over the pipe insert 512. To accommodate the swivel connector 508, there is a flanged split expansion piece 514. The pipe insert 513 is fed by the heating/cooling medium return pipe 105 for carrying the return heating and cooling mediums

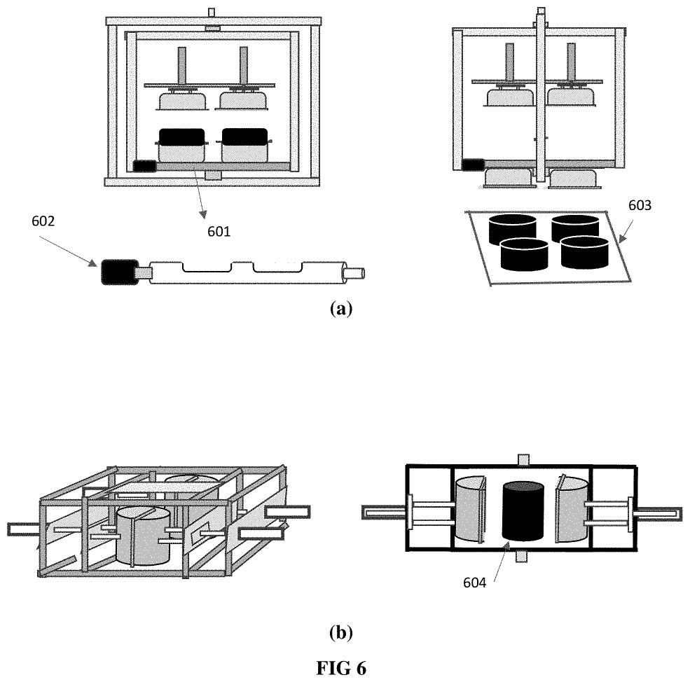

Referring now to FIG. 6, there are provided schematic diagrams showing the demolding and ejection of molded parts in accordance with certain embodiments of the present invention. In certain embodiments, the mold can be opened by hydraulic, pneumatic pistons or electrical actuators.

As shown in FIG. 6(a), the top part of the mold is lifted vertically to reveal the molded part which remains in the lower part. The very good cooling system of the cavity mold system ensures the parting of the mold from the molded section. Mold release coating can be applied to the mold but not normally necessary if the mold is cooled to a low temperature ensuring that the molded piece is no longer sticky.

The lower part of the molds is mounted on a round axle 601 which is rotated by means of an actuator 602 which when rotated 180 degrees releases the molded part(s) 603.

As shown in FIG. 6(b), the molded part(s) 604 is released by way of side ways movement of two pistons or act.

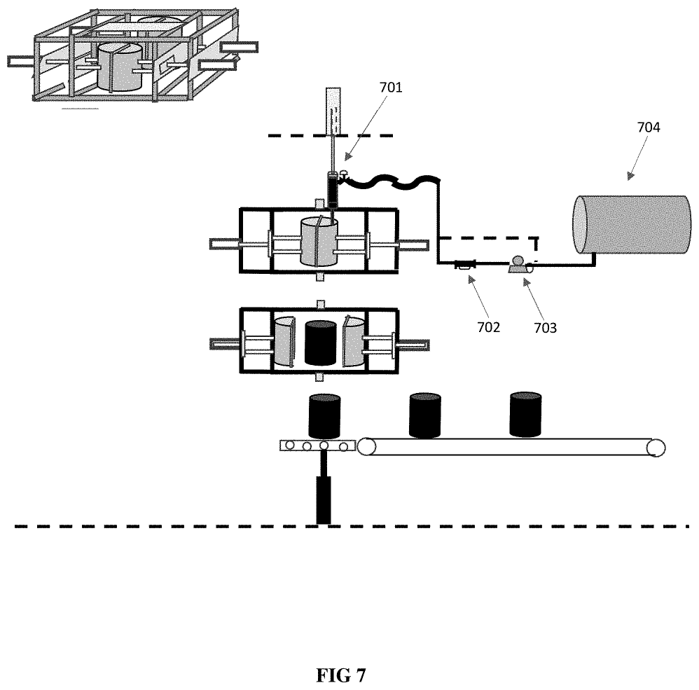

Referring now to FIG. 7, there are provided schematic diagrams showing the filing and opening of the mold in accordance with certain embodiments of the present invention.

As shown in FIG. 7, the filling comprises:

a filling ejector 701 for injection of product to be contained in the molded container;

a positive displacement measuring device 702 for accurately controlling the quantity to be filled; in certain embodiments, the device 702 is a Coriolis meter;

a pump or compressor 703 to supply the product;

a storage tank 704 for the product to fill the casing;

swivel mold demolding system 705.

The cavity mold system of the present invention has many advantages.

The single work station cavity mold system gives the possibility of many different configurations and methods of demolding/ejecting the finished molded item. Designs can be with single or double powered pneumatic, hydraulic cylinders, electrical actuators, worm gears etc. mold closing devices.

The invention enables automatic opening and closing of molds, injection of material to be molded, heating to optimum melt temperature of material to be molded, gradual cooling in a controlled manner to avoid molded part distortions, accurate control of major and minor axis RPM in whatever ratio required, thereby opening up many possibilities that current rotational molding does not.

The single station configuration allows rotational molding to be carried out at one station; in contrast, the current rotational molding requires three different stations.

The mold or molds are mounted on a frame known as a spider in the world of rotational molding; the spider is the internal frame. In current rotational molding designs, the spider is rotated, driven by a chain and beveled gears linked to the main axis motor which is mounted on the outer frame. One reason for this is that the whole spider is normally entered into the oven so if a motor were used, this would require a very special motor capable of withstanding temperatures up to 250° C. With the present invention, as the spider is not subjected to heating in an oven, a standard motor can be utilized. This allows adjusting the speed of rotation of the spider to optimize the molding process as it does not rely on gearing reliant on the main frame motor.

The heating and cooling mediums control module is capable of directly heating and cooling the inner casing by directly utilizing heating and cooling mediums. The temperatures of these mediums can be controlled to accurately deliver the optimum processing temperatures, ensuring that materials are not over-heated, being heated too rapidly, or being cooled too rapidly. This maximizes quality control during molding processes.

The full process, heating & cooling of mold surfaces and production of molded items is achieved at one work station, eliminating the majority of the constraints of the current three station process.

Furthermore, there are advantages of the invention relative to quality control.

The critical function in Rotational Molding is to get heat to the inner surface of the mold to melt the plastic powder, pellets or keep liquid hot which in turns is distributed evenly on the inner surface of the mold by biaxial rotating of the mold(s).

With the invention, the design of the heating and cooling systems is such that the hot and chilled media are accurately controlled and channeled directly to the surface that requires heating and cooling, not the total mold and environment around the mold, including supports which wastes a very high proportion of the energy utilized in current cavity mold systems.

With current rotational molding system where the total mold is inserted into an oven, there can be heat blasts from the ovens burners creating hot spots on molds. This can cause burning of the product being molded. Degradation of resin due to too high temperatures also can occur. To the contrary, there can also be spots that are not heated sufficiently leading to insufficient fusion of resins/materials.

The invention applies a controlled heat or cold medium directly to the inner surface of the molds. The molds are designed with a cavity between the inner and outer surfaces into which the heated or chilled thermal oil, water, liquid ice, air or gases are pumped or compressed. The main body of the mold does not need to be heated to the processing temperature. By having the inside surface of the mold, which the processing surface, made of a good conducting material for example aluminum, copper, stainless steel, iron, brass, lead or silver with the outer section of the mold constructed of a poor conducting material such as rubber, fiber glass, and most plastics, the dissipation/loss is kept to an absolute minimum thereby maximizing the efficiency of the heating and cooling system.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is defined by the appended claims and is supported by the foregoing description.

What is claimed is:

1. A cavity mold comprising:
two or more sub-molds; and
one or more gasket disposed between two adjacent sub-molds; wherein the gasket seals heating and cooling mediums when the cavity mold is assembled;
wherein each of the two or more sub-molds comprises:
an outer casing;
an inner casing on which a molded item is formed, wherein the cavity mold is assembled, a cavity is formed in the space between the outer casing and the inner casing;
at least one heating/cooling mediums input pipe that is fluidly coupled with heating and cooling medium sources and the cavity, wherein heating and cooling mediums are pumped or compressed via the at least one heating/cooling mediums input pipe into the cavity, thereby the heating and cooling mediums pass through the cavity of the cavity mold; and
at least one heating/cooling mediums return pipe that is fluidly coupled with the heating and cooling medium sources and the cavity, wherein the heating and cooling mediums are pumped via the at least one heating/cooling mediums return pipe out of the cavity; and
wherein at least one of the two or more sub-molds further comprises a feed channel being through the outer casing and the inner casing; wherein the feed channel allows molding materials to be fed into the inside of the inner casing.

2. The cavity mold of claim 1, wherein each of the two or more sub-molds further comprises:
at least two isolation valves for regulating the heating or cooling medium flows; wherein one of the at least two isolation valves is disposed on the at least one heating/cooling mediums input pipe, and one of the at least two isolation valves is disposed at least one heating/cooling mediums return pipe.

3. The cavity mold of claim 1, wherein each of the two or more sub-molds further comprises:
at least one temperature sensor being disposed on the outer casing and inside the cavity for recording the temperature of the heating and cooling mediums.

4. The cavity mold of claim 1, wherein the feed channel serves as a vent to release any pressure inside the cavity mold.

5. The cavity mold of claim 1, wherein each of the two or more sub-molds further comprises at least two bushes being provided on the mold flange of the sub-molds for allowing a guide rod to ensure accurate alignment of the sub-molds.

6. The cavity mold of claim 1, wherein the inner casing and the outer casing can be assembled and disassembled;
thereby the inner casing is replaceable.

7. The cavity mold of claim 1, wherein the inner casing and the outer casing are fixed together.

8. The cavity mold of claim 2, wherein the at least two isolation valves enable removal or replacement of the cavity mold.

9. A rotational frame subsystem comprising:
an inner frame serving as a secondary rotating carriage supporting the cavity mold and opening/closing the cavity mold;
an outer frame serving as a primary rotating carriage; wherein the inner frame is disposed within the outer frame;
a support structure;
an inner frame driving motor being disposed onto the outer frame, and being mechanically coupled with the inner frame; wherein the inner frame driving motor revolves the inner frame as the secondary rotation; and
an outer frame driving motor being disposed onto the support structure via a motor joint, and mechanically coupled with the outer frame, where the outer frame driving motor revolves the outer frame as the main rotation; and
a first multi-pipe rotary joint being mounted on the support structure and connecting the outer frame to the support structure;
a second multi-pipe rotary joint being mounted on an inner frame and connecting the outer frame and the inner frame; wherein the first multi-pipe rotary joint allows pipes for input medium and return medium to be fed along a member of the outer frame to the second multi-pipe rotary joint; wherein the second multi-pipe rotary joint is fluidly coupled with a heating/cooling medium input pipe so that the heating/cooling input medium is fed into the cavity of the cavity mold; and wherein the second multi-pipe rotary joint is also fluidly coupled with a heating/cooling medium return pipe so that the heating/cooling return medium from the cavity of the cavity mold is returned to the first multi-pipe rotary joint.

10. The rotational frame subsystem of claim 9, further comprising a guide rod being fitted onto the inner frame, wherein the cavity mold slides along the guide rod to ensure accurate mating of the sub-molds.

11. The rotational frame subsystem of claim 9, wherein the inner frame driving motor is electrically coupled with an electrical supply panel by a power cable that is fitted along the outer frame, and the power cable passes an electrical slip ring that is fitted in the motor joint being disposed onto the support structure.

12. The rotational frame subsystem of claim 9, further comprising means for opening and closing the sub-molds of the cavity molds.

13. The rotational frame subsystem of claim 9, wherein the first or second multi-pipe rotary joint comprises:
an upper flanged both ends tube;
three swivel connectors;
supports; wherein the three swivel connectors are mounted on the supports and disposed within the upper flanged both ends tube; and
a slew bearing being disposed between the upper flanged both ends tube when the joints are assembled.

14. The rotational frame subsystem of claim 9, wherein the first or second multi-pipe rotary joint comprises:
an input pipe insert being fitted over a hydraulic/pneumatic line, and fed by the heating/cooling medium input pipe for carrying the input heating and cooling mediums;
a return pipe insert being fitted over the input pipe insert, and fed by the heating/cooling medium return pipe for carrying the return heating and cooling mediums;
thereby the first and second multi-pipe rotary joints have a pipe within pipe configuration.

15. A cavity mold system comprising:
a cavity mold comprising:
two or more sub-molds; and
one or more gasket disposed between two adjacent sub-molds; wherein the gasket seals heating and cooling mediums when the cavity mold is assembled;
wherein each of the two or more sub-molds comprises:
an outer casing;
an inner casing on which a molded item is formed, wherein the cavity mold is assembled, a cavity is formed in the space between the outer casing and the inner casing;
at least one heating/cooling mediums input pipe that is fluidly coupled with heating and cooling medium sources and the cavity, wherein heating and cooling mediums are pumped or compressed via the at least one heating/cooling mediums input pipe into the cavity, thereby the heating and cooling mediums pass through the cavity of the cavity mold; and
at least one heating/cooling mediums return pipe that is fluidly coupled with the heating and cooling medium sources and the cavity, wherein the heating and cooling mediums are pumped via the at least one heating/cooling mediums return pipe out of the cavity; and
wherein at least one of the two or more sub-molds further comprises a feed channel being through the outer casing and the inner casing; wherein the feed channel allows molding materials to be fed into the inside of the inner casing;
a rotational frame subsystem comprising:
an inner frame serving as a secondary rotating carriage supporting the cavity mold and opening/closing the cavity mold;
an outer frame serving as a primary rotating carriage; wherein the inner frame is disposed within the outer frame;
a support structure;
an inner frame driving motor being disposed onto the outer frame, and being mechanically coupled with the inner frame; wherein the inner frame driving motor revolves the inner frame as the secondary rotation; and
an outer frame driving motor being disposed onto the support structure via a motor joint, and mechanically coupled with the outer frame, where the outer frame driving motor revolves the outer frame as the main rotation; and
a first multi-pipe rotary joint being mounted on the support structure and connecting the outer frame to the support structure;
a second multi-pipe rotary joint being mounted on an inner frame and connecting the outer frame and the inner frame; wherein the first multi-pipe rotary joint allows pipes for input medium and return medium to be fed along a member of the outer frame to the second multi-pipe rotary joint; wherein the second multi-pipe rotary joint is fluidly coupled with the heating/cooling medium input pipe so that the heating/cooling input medium is fed into the cavity of the cavity mold; and wherein the second multi-pipe rotary joint is also fluidly coupled with the heating/cooling medium return pipe so that the heating/cooling return medium from the cavity of the cavity mold is returned to the first multi-pipe rotary joint; and
a heating and cooling medium subsystem for providing the heating and cooling mediums and controlling the temperatures of the heating and cooling mediums.

16. The cavity mold system of claim 15, wherein the rotational frame subsystem further comprises a guide rod being fitted onto the inner frame, wherein the cavity mold slides along the guide rod to ensure accurate mating of the sub-molds.

17. The cavity mold system of claim 15, wherein the inner frame driving motor is electrically coupled with an electrical supply panel by a power cable that is fitted along the outer frame, and the power cable passes an electrical slip ring that is fitted in the motor joint being disposed onto the support structure.

18. The cavity mold system of claim 15, wherein the rotational frame subsystem further comprises means for opening and closing the sub-molds of the cavity molds.

19. The cavity mold system of claim 15, wherein the heating and cooling medium subsystem comprises:
a heating medium storage tank for storing the heating medium;
a heating medium pump being disposed downstream of the heating medium storage tank;
a heating medium metering means being disposed downstream of the heating medium pump; wherein the heating medium metering means monitors the temperature, volume and density of the heating medium passing through and feeds data to a PLC;
a heating medium control valve being disposed downstream of the heating medium metering means; wherein the heating medium control valve adjusts the flow of the heating medium based on the PLC output command;
a cooling medium storage tank for storing the cooling medium;
a cooling medium pump being disposed downstream of the cooling medium storage tank;
a cooling medium metering means being disposed downstream of the cooling medium pump; wherein the cooling medium metering means monitors the temperature, volume and density of the cooling medium passing through and feeds data to the PLC;
a cooling medium control valve being disposed downstream of the cooling medium metering means; wherein the cooling medium control valve adjusts the flow of the cooling medium based on the PLC output command;
an inline mixer being disposed downstream of both the heating medium control valve and the cooling medium control valve; wherein the inline mixer mixes the heating and cooling mediums are mixed to give a desired temperature to a heating/cooling input medium;
a heating medium return control valve being disposed downstream of the first multi-pipe rotary joint; wherein the heating medium return control valve is controlled by the PLC to direct the heating return medium to the heating medium storage tank; and
a cooling medium return control valve being disposed downstream of the first multi-pipe rotary joint; wherein the cooling medium return control valve is controlled by the PLC to direct the cooling return medium to the cooling medium storage tank.

20. The cavity mold system of claim 19, wherein the heating medium metering means and the cooling medium metering means are a Coriolis meter.

21. The cavity mold system of claim 15, wherein the first or second multi-pipe rotary joint comprises:
an upper flanged both ends tube;
three swivel connectors;
supports; wherein the three swivel connectors are mounted on the supports and disposed within the upper flanged both ends tube; and
a slew bearing being disposed between the upper flanged both ends tube when the joints are assembled.

22. The cavity mold system of claim 15, wherein the first or second multi-pipe rotary joint comprises:
an input pipe insert being fitted over a hydraulic/pneumatic line, and fed by the heating/cooling medium input pipe for carrying the input heating and cooling mediums;
a return pipe insert being fitted over the input pipe insert, and fed by the heating/cooling medium return pipe for carrying the return heating and cooling mediums;
thereby the first and second multi-pipe rotary joints have a pipe within pipe configuration.
